(19) United States
(12) Patent Application Publication
(10) Pub. No.: US 2015/0193213 A1
(43) Pub. Date: Jul. 9, 2015

(54) Computer Implemented System and Method for Checking a Program Code

(71) Applicant: Tata Consultancy Services Ltd., Mumbai (IN)

(72) Inventors: Mayuresh P. Warunjikar, Pune (IN); Priyam Jain, Pune (IN); Neeraj Jain, Pune (IN); Nitin Kumar Rai, Pune (IN); Vivek Tiwari, Pune (IN); Amit Kumar Choubey, Pune (IN)

(21) Appl. No.: 14/504,724

(22) Filed: Oct. 2, 2014

(30) Foreign Application Priority Data
Jan. 6, 2014 (IN) 41/MUM/2014

(51) Int. Cl. G06F 9/45

(52) U.S. Cl. CPC G06F 8/425; G06F 8/427

(57) ABSTRACT

A computer implemented system for checking a program code that includes a lexical analyzer to lexically analyze the expressions of the program code and generate tokens representing these expressions. The system includes a parser that receives and parses the tokens to determine whether the tokens form an allowable expression. A tree generation module generates a parsed tree that represents relationship between the tokens in a tree-format. The system further includes an abstractor that cooperates with the tree generation module, and stores at least one meta model that represents program code in an entity-relationship format. A rule engine executes the code checking rule(s) on the populated instance of the meta model, and determines whether said program code complies with the code checking rule(s). The system also includes a report generator that generates at least one report indicating the compliance level of the program code with the code-checking rule(s).

### FIELD OF DISCLOSURE

The present disclosure relates to the field of code checking. More particularly, the present disclosure relates to a system for checking whether a program code complies with code checking rules.

### DEFINITIONS OF TERMS USED IN THE DISCLOSURE

The expression ‘entity-relationship model’ used hereinafter in the disclosure refers to a data model representation describing the relationships between the entities present in a model and the respective entity-types.

The expression ‘rule base’ used hereinafter in the disclosure refers to a repository that stores rule sets in a list format.

The expression ‘violations’ used hereinafter in this disclosure refers to occurrence of code patterns that do not comply with a set of code checking rules.

The term ‘allowable expression’ used hereinafter in the disclosure refers to an expression which is in accordance with the grammar of the language used for creating the expression.

These definitions are in addition to those expressed in the art.

### BACKGROUND

Code checking tools are designed to check codes in order to determine whether the code is in compliance with a set of pre-determined code checking rules. These tools are used by code reviewers (programmers) to help them discover violations of a predetermined set of rules. Code checking is typically preceded by a step of parsing. Parsing of a code involves syntactic analysis of the code to ascertain that it complies with the code's grammar among other things and provides transformation of the code into its constituents in the form of a data structure, such as a parsed tree. A code checking tool is used to find or determine the occurrence of violations (of the set of pre-determined code checking rules) in a software program.

However, a parsed tree represents a low level of abstraction and involves utilization of low-level data structures. Methods such as XML queries are utilized to elicit simple limited patterns of interest from the parsed trees. For more complicated patterns the reviewer is required to use a general purpose programming language. The use of XML queries or the general purpose programming language requires prolonged efforts and skills on the part of the code reviewer checking the program code. Since utilization of a general purpose programming language may be necessary to search for complex patterns in a parsed tree, it makes the development and maintenance of code checking rules cumbersome when using conventional code checking tools to review the code repositories.

Moreover, prior art code checking rules of these tools themselves involve writing lengthy codes (necessary for identifying programming errors). The size and the length of the code that is required to be written for the code checking rules render them relatively complicated and prone to errors. The incorporation and implementation of lengthy code cannot guarantee that the code checking rules themselves are free of programming errors.

Various types of code checking tools such as PMD, Sonar, Findbugs and check style are available for checking code. PMD, a widely used code checking tool emphasizes on building an abstract syntax tree (AST) of a software program and makes the abstract syntax tree available in the form of an extensible mark-up language (XML), for querying patterns of interest. The AST of PMD is itself a complex representation of the program code, which necessitates scripting of a lengthy program code for bringing about such a representation. Conventional code checking tools such as PMD therefore involve scripting of lengthy codes which is associated with the risks discussed above.

A new approach is therefore necessary, which will result in creation of a code checking tool which is efficient in terms of checking a software program code for compliance with code checking rules.

### OBJECTS

Some of the objects of the present disclosure, aimed at ameliorating one or more problems of the prior art, are described herein below:

An object of the present disclosure is to provide a system that implements a high level of abstraction on the input source code and generates high level entity-relationship models corresponding to the input source code.

Yet another object of the present disclosure is to provide a system that enables creation of complex code checking rules without necessitating use of general purpose programming languages.

Still a further object of the present disclosure is to provide a system that expresses the code checking rules using a backward chaining rule engine.

Another object of the present disclosure is to provide a system that enables creation of customized code checking rules.

One more object of the present disclosure is to provide a system that generates models and code checking rules suitable for diversified programming languages.

Another object of the present disclosure is to provide an approach for code checking, that is language agnostic.

Still another object of the present disclosure is to provide a system that does not necessitate use of a general purpose programming language to search a parsed tree for patterns indicating the violation of code checking rules.

Another object of the present disclosure is to provide a system that improves the processing time associated with code analysis.

Yet another object of the present disclosure is to provide a system that makes the development, maintenance and customization of code checking rules relatively non-cumbersome and more efficient.

Yet another object of the present disclosure is to provide a system which optimizes the efficiency associated with code checking, by using timestamp comparisons so that code checking rules once applied on a program code do not have to be reapplied until either the rules or the program code on which they are applied undergo a modification.

Other objects and advantages of the present invention will be more apparent from the following description when read in conjunction with the accompanying figures, which are not intended to limit the scope of the present disclosure.

### SUMMARY

The present disclosure envisages a computer implemented system for checking a program code. The system, in accordance with the present disclosure comprises:
a lexical analyzer comprising a first repository having a pre-determined set of lexical rules stored therein, the lexical analyzer further comprising a first processor configured to lexically analyze the expressions of the program code and generate tokens representing the expressions;
a parser cooperating with the lexical analyzer configured to receive and adapted to parse the tokens, the parser comprising a second repository having a pre-determined set of parsing rules stored therein, the parser further comprising a determinator configured to determine whether the tokens form an allowable expression;
a tree generation module cooperating with the parser and configured to generate a parsed tree, the parsed tree representing the relationship between the tokens in a tree-format;
an abstractor cooperating with the tree generation module configured to receive the parsed tree, the abstractor comprising:
   a third repository configured to store at least one meta model, the meta model representing the program code in an entity-relationship format;
   a fourth repository configured to store at least one set of populating rules corresponding to the meta model;
   a second processor configured to receive the meta model, the populating rules and the parsed tree, the second processor configured to populate an instance of the meta model, based on the parsed tree and in accordance with the populating rules;
a rule engine comprising:
   a receiver configured to receive the populated instance of the meta model;
   a framer accessible to a code reviewer, the reviewer having access to the program code and the corresponding program requisites, the framer configured to enable the reviewer to frame at least one code checking rule based on the program requisites;
   a fifth repository cooperating with the framer to receive the code checking rules, the fifth repository configured to store the received code checking rule(s); and
   a third processor cooperating with the fifth repository and configured to execute the code checking rule(s) on the populated instance of the meta model, and determine whether the program code complies with the code checking rule(s); and
a report generator cooperating with the rule engine and configured to generate at least one report indicating the compliance level of the program code with the code-checking rule(s).

In accordance with the present disclosure, the system further includes:
a time stamp checker configured to receive the program code, the program code comprising a first time stamp indicating the date of and the time at which the program code was last modified, and a second time stamp indicating the date of and time at which the program code was previously checked by the system; and
a comparator configured to compare the first time stamp and the second time stamp, and instruct the report generator to generate a report in the event that first time stamp is less than the second time stamp; the comparator further configured to instruct the lexical analyzer to lexically analyze the program code, in the event that the first time stamp is greater than the second time stamp.

In accordance with the present disclosure, the system further comprises a translator configured to selectively translate the code checking rule(s) into a format compatible with the meta model, prior to the execution of the code checking rule(s).

In accordance with the present disclosure, the instance of the meta-model is an entity-relationship model.

In accordance with the present disclosure, the code checking rule(s) are organized into a plurality of rule bases.

In accordance with the present disclosure, the system further includes an activator accessible to the reviewer, the activator configured to enable the reviewer to selectively activate the code checking rule(s) organized into the plurality of rule bases.

In accordance with the present disclosure, the system further includes a rule-editor configured to enable the reviewer to edit the code checking rule(s).

The present disclosure envisages a computer implemented method for checking a program code. The method, in accordance with the present disclosure comprises the following steps:
storing, a pre-determined set of lexical rules on a first repository, a pre-determined set of parsing rules on a second repository, at least one meta model in a third repository, at least one set of populating rules corresponding to the meta model on a fourth repository;
lexically analyzing the expressions of the program code using the set of lexical rules and generating tokens corresponding to the expressions provided in the program code;
parsing the tokens using the set of pre-determined parsing rules and determining whether the token form an allowable expression;
generating a parsed tree representing the relationship between the tokens in a tree-format;
receiving the parsed tree at an abstractor and selectively extracting the meta model and at least one set of populating rules corresponding to the meta model;
generating a populated instance of the meta model based on the tree and in accordance with the populating rules;
enabling a code reviewer having access to the program code and the corresponding program requisites, to frame at least one code checking rule in accordance with the program requisites;
storing the code checking rule(s) in a fifth repository;
receiving the populated instance of the meta model at a rule engine and selectively extracting the code checking rule(s), and further executing the code checking rule(s) on the populated instance of the meta model; and
determining whether the program code complies with the code-checking rules, and generating at least one report indicating the compliance level of the program code with the code-checking rules.

In accordance with the present disclosure, the method further includes the following steps:
extracting a first time stamp, wherein the first time stamp indicates the date of and time at which the program code was last modified;
extracting a second time stamp, wherein the second time stamp indicates the date of and time at which the program code was last checked by the system; and
comparing the first time stamp with the second time stamp.

In accordance with the present disclosure, the step of comparing the first time stamp with the second time stamp further includes the step of instructing a report generator to generate a report indicating the compliance level of the program code with the code-checking rules, in the event that first time stamp is less than the second time stamp.

In accordance with the present disclosure, the step of comparing the first time stamp with the second time stamp further includes the step of instructing a lexical analyzer to lexically analyze the program code, in the event that the first time stamp is greater than the second time stamp.

In accordance with the present disclosure, the method further includes the step of selectively translating the code checking rule(s) into a format compatible with the meta model, prior to the execution of the code checking rule(s).

In accordance with the present disclosure, the step of generating the populated instance of the meta model further includes the step of generating an entity relationship model.

In accordance with the present disclosure, the method further includes the step of organizing the code checking rules into a plurality of rule bases.

In accordance with the present disclosure, the method further includes the step of enabling a code reviewer to selectively activate the code checking rules organized into the plurality of rule bases.

In accordance with the present disclosure, the method further includes the following steps:
enabling the reviewer to customize the created code checking rules; and
updating the fifth repository with customized code checking rules.

### BRIEF DESCRIPTION OF THE ACCOMPANYING DRAWINGS

The computer implemented system and method for checking a program code will now be explained with respect to the non-limiting accompanying drawings which do not restrict the scope and ambit of the present disclosure. The drawings include:

FIG. 1 illustrating a system-level block diagram of the components of the system;

FIG. 2, a system-level block diagram of the components of the system, in accordance with another embodiment of the present disclosure; and

FIG. 3 and FIG. 4, in combination illustrating the steps involved in the flowchart corresponding to the method for checking a program code.

### DETAILED DESCRIPTION

To obviate the drawbacks associated with the prior art code checking systems and methods, the present disclosure envisages a computer implemented system and method which generates code checking rules that do not involve usage of general purpose programming language. The present disclosure envisages a language agnostic system which can be utilized to check the compliance of a program code with code checking rules. The system envisaged by the present disclosure provides for a high level abstraction of the corresponding program code, using E-R models, thereby making the task of searching for programming errors (based on code checking rules) easier and faster. Moreover, the system is suitable for a program code that uses any procedural or object oriented programming language. Additionally, the system envisaged by the present disclosure does not necessitate use of a general purpose programming language. The system also enables generation of code checking rules for program codes scripted using a particular programming language. Typically, the code checking rules are generic, or specific to an architecture or design, thereby enabling the reuse of these rules. If additional code checking rules are required for a particular program code, the code checking rules can be customized prior to their implementation.

The present disclosure envisages a system that uses a backward chaining rule engine to express the code checking rules. The process of chaining is utilized to traverse a given model. Chaining involves reinforcing individual responses occurring in a sequence to form a complex behavior. Chaining refers to sharing conditions between rules, so that the same condition is evaluated only once for all the rules. When one or more conditions are shared between rules, the rules are considered to be chained. The available chaining techniques include forward chaining rule technique and backward chaining technique.

The system of the present disclosure also provides for a high level of abstraction and ease of writing efficient code checking rules which do not involve usage of a general purpose programing language. The present disclosure also envisages a system that optimizes the processing time associated with code checking.

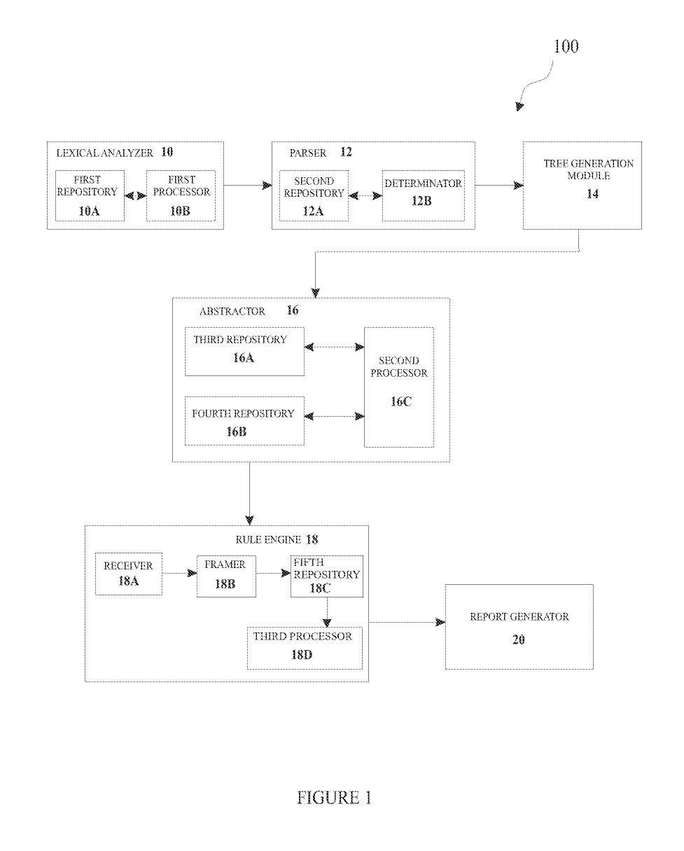

Referring to FIG. 1, there is shown a computer implemented system 100 for checking whether a program code complies with code checking rules. The system receives a software program code that needs to be checked for compliance with the code checking rules, as an input. The system in accordance with the present disclosure includes a lexical analyzer 10 comprising a first repository 10A having a pre-determined set of lexical rules stored therein. The lexical analyzer 10 includes a first processor denoted by the reference numeral 10B configured to lexically analyze the expressions included in the input software program code. The processor 10B converts the sequence of characters (including special characters, numerals and alphabets) included in the input software program code into a sequence of tokens. A ‘token’ is a collection of one or more characters that is significant as a group. The tokens are identified based on the lexical rules stored in the repository 10A. The processor 10B makes use of regular expressions, specific sequence of characters, special separating characters (such as delimiters), and special characters (including punctuation characters) to identify the tokens. The processor 10B typically categorizes tokens by the corresponding character content or by context. The categories are also governed by the lexical rules stored in the repository 10A. For example, the processor 10B analyzes the input software program code by reading a particular stream of characters. The processor 10B subsequently identifies the lexemes' in the read stream and categorizes the lexemes into tokens. For example, in an expression “sum=3+2;” the lexemes identified are sum, =, 3, +, 2 and ;. The lexeme ‘sum’ is an identifier, the lexeme ‘=’ is an assignment operator, the lexeme ‘3’ is an integer literal, the lexeme ‘+’ is an addition operator, the lexeme ‘2’ is an integer literal and the lexeme ‘;’ denotes end of the statement. In accordance with the present disclosure, each of the identified lexemes is classified as a token. The lexical rules stored in the repository 10A ensure that no meaningless tokens are generated.

The system 100, in accordance with the present disclosure includes a parser denoted by the reference numeral 12. The parser 12, in accordance with the present disclosure receives the tokens as an input from the lexical analyzer 10 and provides a structural representation to the received tokens, typically by arranging them in the form of a data structure. The parser 12, in accordance with the present disclosure comprises a determinator 12B which checks whether the received tokens, in combination, form an allowable expression. The determinator 12B performs the aforementioned checking based on a set of pre-determined parsing rules stored in a second repository 12A.

The system 100, in accordance with the present disclosure, includes a tree-generation module denoted by the reference numeral 14. The tree generation module 14, in accordance with the present disclosure cooperates with the parser 12 to receive the tokens and generate a parsed tree representing the relationship between the tokens.

The system 100, in accordance with the present disclosure, includes an abstractor denoted by the reference numeral 16. The abstractor 16, in accordance with the present disclosure, cooperates with the tree generation module 14 to receive the parsed tree. The abstractor 16 further includes a third repository 16A configured to store at least one meta model. In a research paper titled “How to represent Models, Languages and Transformations”, the author ‘Martin Feilkas’ proposes a method of translating context free grammars into ER-schemata and optimizing the context free grammar towards context sensitive rules. The author proposes building a meta model based on the relationships embodied in the code written in an ordinary programming language, and also emphasizes on formulation of a computer program code into a corresponding relationship model, and ensuring semantic and syntactical correctness of such a formulation.

The meta model, in accordance with the present disclosure, is an entity-relationship model. The meta model is configured to represent the input software program code in terms of the relationship between the entities of the input software program code. The abstractor 16 further includes a fourth repository 16B configured to store at least one set of populating rules utilized to populate at least one instance of the meta model. The abstractor 16 further includes a second processor 16C configured to receive the meta model, the populating rules and the parsed tree. The second processor 16C is configured to populate at least one instance of the meta model based on the received parsed tree and in accordance with the populating rules received from the second repository 16B.

The system 100, in accordance with the present disclosure, further includes a rule engine denoted by the reference numeral 18. The rule engine 18, in accordance with the present disclosure includes a receiver 18A configured to receive the populated instance of the meta model. The rule engine 18 further includes a framer 18B accessible to a code reviewer. The term ‘reviewer’ in case of this specification represents a code checking architect/programmer. The reviewer is also provided with access to the input software program code, i.e., the software program code that requires to be checked for compliance. Alternatively, the reviewer can also define his own set of program requisites. The framer 18B enables the reviewer to frame at least one code checking rule in accordance with the program requisites corresponding to the input software program code. The code checking rule(s) framed by the reviewer are stored in a fifth repository 18C.

The rule engine 18 further includes a third processor 18D configured to execute the code checking rules on the received populated instance of the meta model and identify whether the populated instance of the meta model (representing the input software program code) complies with the code checking rules.

In accordance with the present disclosure, the system 100 provides for the analysis of the input software program code and provides for determination of the corresponding program requisites. The framer 18B enables the reviewer (code reviewer) to frame code checking rules that are in-line with the corresponding program requisites. Subsequent to the implementation of the code checking rules on the input software program code, the code checking rules which are generic in nature and which can be implemented on diversified software program codes are retained in the repository 18C, thereby promoting reuse of the generic code checking rules. In accordance with the present disclosure, when a new software program code is input to the system 100 for the purpose of code checking, the new software program code is represented as a meta model, as explained in the earlier sections, and the program requisites corresponding to the new software program code are determined. Further, the fifth repository 18C is searched for code checking rules that can be reused on the new software program code. The code checking rules that are in accordance with the program requisites corresponding to the new software program code are subsequently reused.

The system 100, in accordance with the present disclosure, includes a report generator denoted by the reference numeral 20. The report generator 20 cooperates with the rule engine 18 and generates at least one report indicating the level of compliance of the input software program code with the code checking rules.

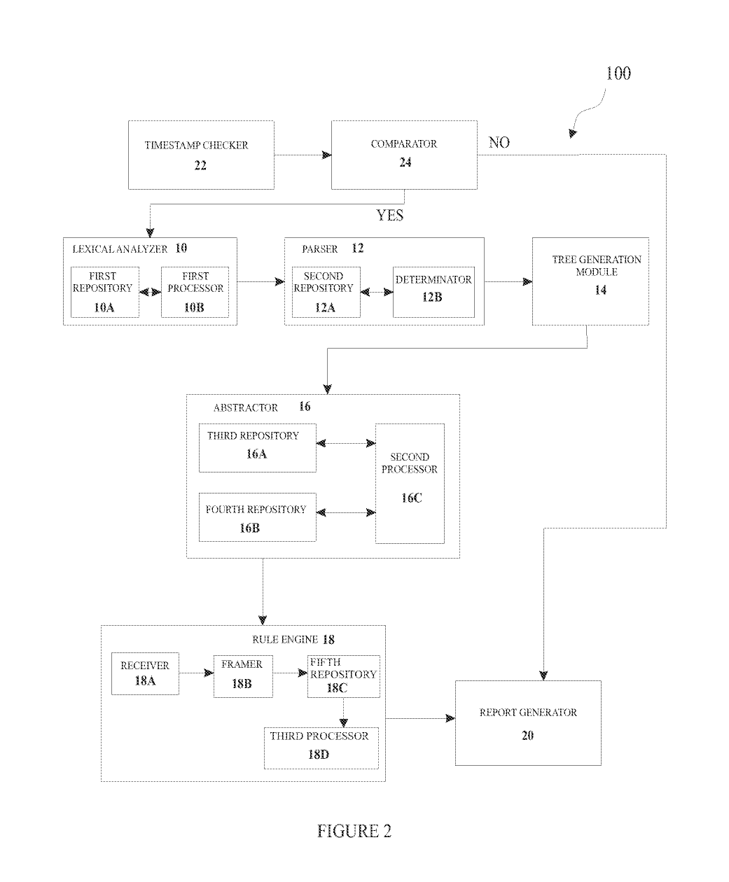

Referring to FIG. 2, there is shown an embodiment of the present disclosure wherein the computer implemented system 100 includes a time stamp checker 22 and a comparator 24. The rest of the components and their respective functionalities remain the same as explained in the aforementioned paragraphs. The rest of the components are enumerated using the same reference numerals as in FIG. 1. In accordance with this embodiment, the input software program code comprises a first time stamp indicating the date of and the time at which the input software program code was last modified, and a second time stamp indicating the date of and time at which the input software program code was previously checked by the system 100. The time stamp checker 22, in accordance with this embodiment is configured to receive the first time stamp and the second time stamp. The system 100, in accordance with this embodiment further includes a comparator 24 configured to compare the first time stamp and the second time stamp. The comparator 24, subsequent to the comparison of both the time stamps, determines whether the first time stamp (the time stamp indicating the date of and the time at which the program code was last modified) is greater than the second time stamp (the time stamp indicating the date of and time at which the input software program code was previously checked by the system 100). If the first time stamp is determined to be greater than the second time stamp, it is meant that the input software program code has been modified after it has been last checked by the system 100. Subsequently, the comparator 24 instructs the lexical analyzer to begin lexical analysis of the modified software program code. The lexical analysis of the software program code is followed by the steps of parsing, parsed tree generation, abstraction, application of code checking rules and generation of a report, as explained with reference to FIG. 1. But, subsequent to the comparison, if the comparator 24 determines that the first time stamp is less than the second time stamp, it is meant that the input software program code has not been modified after it has been last checked by the system 100. Subsequently, the comparator 24 decides that since the program code has not been modified since it was last checked by the system 100, there is no necessity for the steps of parsing, parsed tree generation, abstraction, application of code checking rules and generation of a report, to be carried out on the input software program code. Therefore, the comparator instructs the report generator 20 to generate a report on the input software program code, the report being either an extension or a replica of the reports generated when the input software program code was previously checked by the system 100.

In accordance with the present disclosure, the system 100 further includes a translator (not shown in figures) configured to selectively translate the code checking rules into a format compatible with the meta model, prior to the execution of the code checking rules.

In accordance with the present disclosure, the code checking rules stored in the fifth repository 18C are organized into a plurality of rule bases. The system 100, in accordance with the present disclosure, includes an activator (not shown in figures) configured to enable a reviewer to selectively activate the code checking rules (organized into a plurality of rules bases) stored in the fifth repository 18C. In accordance with the present disclosure, the system 100 further includes a rule-editor (not shown in figures) accessible to the reviewer, configured to enable the reviewer to edit the aforementioned customized code checking rules.

In accordance with one embodiment of the present disclosure, the first repository 10A, second repository 12A, third repository 16A, fourth repository 16B and fifth repository 18A are a part of a network of distributed databases interlinked and accessible via a data communication link. In accordance with another embodiment of the present disclosure, the aforementioned repositories are a part of a cloud computing environment and are accessible through a computer connected to the cloud computing environment.

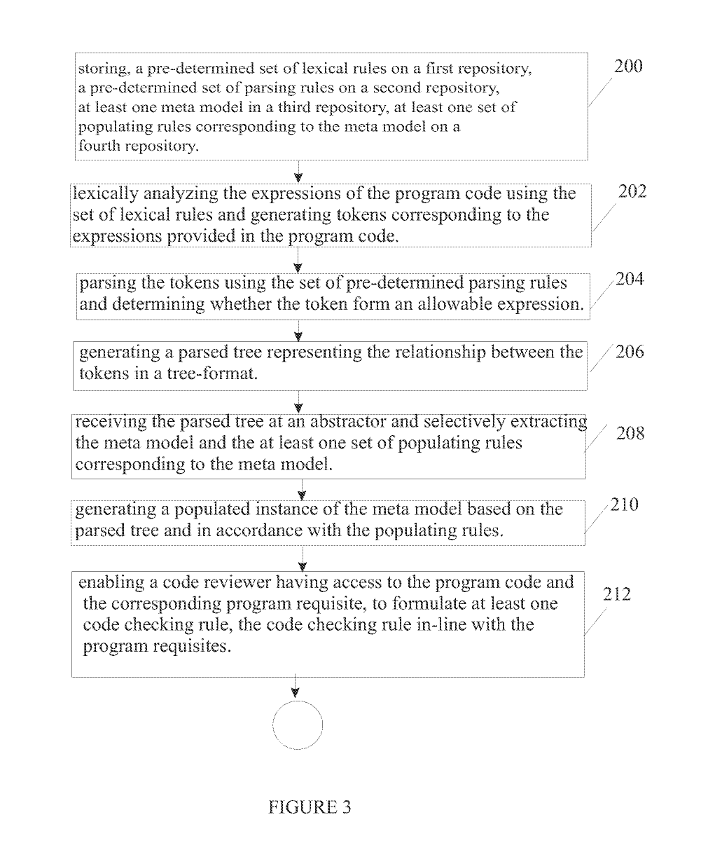

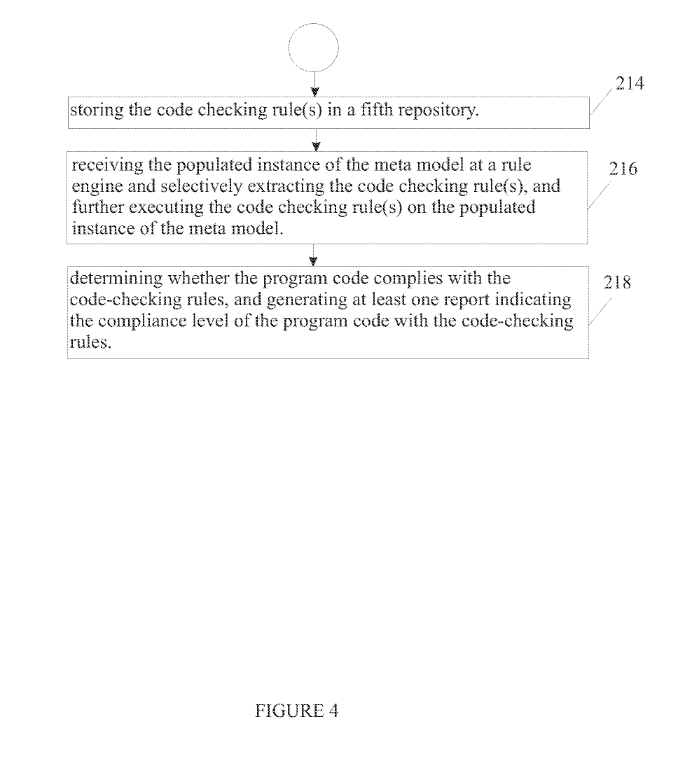

Referring to FIG. 3, there is shown a flow chart illustrating the steps involved in the method for checking a program code. The method, in accordance with the present disclosure includes the following steps:
storing, a pre-determined set of lexical rules on a first repository, a pre-determined set of parsing rules on a second repository, at least one meta model in a third repository, at least one set of populating rules corresponding to the meta model on a fourth repository 200;
lexically analyzing the expressions of the program code using the set of lexical rules and generating tokens corresponding to the expressions provided in the program code 202;
parsing the tokens using the set of pre-determined parsing rules and determining whether the token form an allowable expression 204;
generating a parsed tree representing the relationship between the tokens in a tree-format 206;
receiving the parsed tree at an abstractor and selectively extracting the meta model and the at least one set of populating rules corresponding to the meta model 208;
generating a populated instance of the meta model based on the parsed tree and in accordance with the populating rules 210;
enabling a code reviewer having access to the program code and the corresponding program requisites, to frame at least one code checking rule, in accordance with said program requisites 212;
storing the code checking rule(s) in a fifth repository 214;
receiving the populated instance of the meta model at a rule engine and selectively extracting the code checking rule(s), and further executing the code checking rule(s) on the populated instance of the meta model 216; and
determining whether the program code complies with the code-checking rules, and generating at least one report indicating the compliance level of the program code with the code-checking rules 218.

In accordance with the present disclosure, the method further includes the following steps:
extracting a first time stamp, wherein the first time stamp indicates the date of and time at which the program code was last modified;
extracting a second time stamp, wherein the second time stamp indicates the date of and time at which the program code was last checked by the system; and
comparing the first time stamp with the second time stamp.

In accordance with the present disclosure, the step of comparing the first time stamp with the second time stamp further includes the step of instructing a report generator to generate a report indicating the compliance level of the program code with the code-checking rules, in the event that first time stamp is less than the second time stamp.

In accordance with the present disclosure, the step of comparing the first time stamp with the second time stamp further includes the step of instructing a lexical analyzer to lexically analyze the program code, in the event that the first time stamp is greater than the second time stamp.

In accordance with the present disclosure, the method further includes the step of selectively translating the code checking rule(s) into a format compatible with the meta model, prior to the execution of the code checking rule(s).

In accordance with the present disclosure, the step of generating the populated instance of the meta model further includes the step of generating an entity relationship model.

In accordance with the present disclosure, the method further includes the step of organizing the code checking rules into a plurality of rule bases.

In accordance with the present disclosure, the method further includes the step of enabling a code reviewer to selectively activate the code checking rules organized into the plurality of rule bases.

In accordance with the present disclosure, the method further includes the following steps:
enabling the code reviewer to customize the created code checking rules; and
updating the fifth repository with customized code checking rules.

The advantages of the system envisaged by the present disclosure are exemplified by a comparative analysis between the process of checking of a software program code using the prior art code checking engine PMD, and the tool envisaged by the present disclosure. The software program code under check is purported to be utilized in the ‘Insurance’ domain and includes 750 lines of code. The comparative analysis was carried out by two associates possessing the basic programming skills required to check the software program code. The benchmarking values such as initial learning effort, development effort, defect metrics, and efficiency corresponding to the PMD and the tool envisaged by the present disclosure were comparatively analyzed. The initial learning effort required to implement PMD, involved getting familiar with the tree data structure of PMD, understanding the standard packages available and to be used for writing code checking rules in PMD, understanding the methods to be implemented in PMD to realize a rule, and integrating the given program with the PMD subsequent to implementation of the same. In contrast, the tool envisaged by the present disclosure requires knowledge of only a high level E-R model, as against PMD's tree data structure, thereby contributing to the reduction of the initial learning effort which in case of PMD was 3 person weeks, to 3 person days (in case of the tool envisaged by the present disclosure).

Further, the tool envisaged by the present disclosure does not warrant the use of Java code and XPath queries, in contradiction to PMD, thereby obviating the need for a code reviewer to be acquainted with Java and XPath. Further, the tool of the present disclosure does not necessitate importing of packages and code integration related activities.

The development effort corresponding to the tool envisaged by the present disclosure was computed taking into consideration about 70 code-checking rules. For PMD, it was logistically difficult to undertake a real exercise of such a size (70 code-checking rules) and therefore the development effort was calculated by using average code size per code-checking rule and industry-wide accepted productivity figures from references such as “Capers Jones, Software assessments, benchmarks, and best practices, Addison-Wesley Longman Publishing Co. Inc., Boston, Mass., USA, 2000”, and Industry average productivity figure of 63LOC per day and average PMD rule size of 81 lines per rule (gathered from code checking rules equivalent to those written in accordance with the present invention). The use of PMD necessitated 25 person weeks for writing 100 code checking rules, whereas the tool envisaged by the present disclosure necessitated only 3 person weeks for writing 100 code checking rules, thereby proving the existence of an improvement in the efficiency associated with the entire code checking process.

Further, it is well known that defects in software are hard to detect and they come to light only over time. It is logistically difficult to produce actual number of defect metrics. Therefore, the industry standard figures of defect density based on size of the code were used for calculating the defect metrics. The industry average of 50 defects/KLOC, average code size of 9 lines per rule (based on actual exercise) in case of the tool envisaged by the present disclosure, and 81 lines per rule with PMD (measured from LOC of equivalent rules in PMD), were used for calculating the defect figures. PMD produced a defect rate of 4 defects per rule, whereas the system envisaged by the present disclosure produces a defect rate of 0.4 defects per rule, thereby proving that the system of the present disclosure involves less number of defects per rule, and is free of violations in comparison to PMD.

Further, the system envisaged by the present disclosure is also more efficient in comparison to PMD. For the purpose of measuring the efficiency, a bunch of 10 sample rules were chosen from the tool envisaged by the present disclosure and from PMD. There were two measurements involved—first run and a subsequent run. The tool of the present disclosure caches the data (code checking rules related data) in the first run, i.e., when the code checking rules are implemented on a given software program. The efficiency associated with the code checking process is improved during the subsequent implementations of the process. The tool envisaged by the present disclosure executes 10 rules in 1.9 seconds in a first run, and in a subsequent run, 10 rules are executed in 0.40 seconds, whereas PMD executed 10 rules in 2.4 seconds and also did not provide a facility for caching the violations.

The following benchmarks were utilized, in order to evaluate the tool envisaged by the present disclosure with respect to PMD.
1. Initial learning effort: the initial learning effort symbolizes the learning effort necessitated by a programmer having the requisite skills to learn preparing code checking rules using a given code-checking tool.
2. Development effort: the development effort symbolizes the effort necessitated for developing code checking rules.
3. Defect metrics: the defect metrics are indicative of the maintenance costs associated with the developed code checking rules.
4. Efficiency: the efficiency factor symbolizes the time taken to apply the code checking rules on real time projects necessitating the implementation of code checking rules.

The table 1 provided herein below provides a comparison between the benchmarking values corresponding to the tool envisaged by the present disclosure and PMD.

TABLE 1
comparison between the benchmarking values corresponding
to the tool envisaged by the present disclosure and PMD.

| | Tool of the present | |
|---|---|---|
| Metric | disclosure | PMD |
| Initial learning | 3 person days | 3 person weeks |
| effort | | |
| Development | 3 person weeks/100 rules | 25 person weeks/100 rules |
| effort | | |
| Defect metrics | 0.4 defects/rule | 4 defects/rule |
| Efficiency | First run: 1.9 s/10 rules; | 2.4 s/10 rules for either run |
| | Subsequent run: 0.4 s/10 | |
| | rules | |

### Technical Advancements

The technical advancements of the computer implemented system for checking whether a program code complies with a set of pre-determined rules, as envisaged by the present disclosure include the realization of:
a system that implements a higher level of abstraction on the input source code and generates high level entity-relationship models corresponding to the input source code;
a system that enables creation of complex code checking rules without necessitating use of general purpose programming languages;
a system that provides for creation of customized code checking rules;
a system that expresses the code checking rules using a backward chaining rule engine;
a system that generates models suitable for diversified programming languages;
a system that generates code checking rules that are language agnostic;
a system that does not require a general purpose programming language which could increase the effort to code the rules and also increase the susceptibility to defects in the code due to the code size;
a system that improves the processing time associated with code analysis;
a system that makes the development, maintenance and customization of code checking rules less cumbersome; and
a system which optimizes the efficiency associated with code checking by using timestamp comparisons so that rules once applied do not have to be applied again until either the rules or the program on which they are applied undergo a change.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A computer implemented system for checking a program code, said system comprising:
a lexical analyzer comprising a first repository having a pre-determined set of lexical rules stored therein, said lexical analyzer further comprising a first processor configured to lexically analyze the expressions of said program code and generate tokens representing said expressions;
a parser cooperating with said lexical analyzer configured to receive and adapted to parse said tokens, said parser comprising a second repository having a pre-determined set of parsing rules stored therein, said parser further comprising a determinator configured to determine whether said tokens form an allowable expression;
a tree generation module cooperating with said parser and configured to generate a parsed tree, said parsed tree representing the relationship between said tokens in a tree-format;
an abstractor cooperating with said tree generation module configured to receive said parsed tree, said abstractor comprising:
a third repository configured to store at least one meta model, said meta model representing said program code in an entity-relationship format;
a fourth repository configured to store at least one set of populating rules corresponding to said meta model;
a second processor configured to receive said meta model, said populating rules and said parsed tree, said second processor configured to populate an instance of said meta model, based on said parsed tree and in accordance with said populating rules;
a rule engine comprising:
a receiver configured to receive the populated instance of said meta model;
a framer accessible to a code reviewer, said reviewer having access to said program code and corresponding program requisites, said framer configured to enable said reviewer to frame at least one code checking rule based on said program requisites;
a fifth repository cooperating with said framer to receive said code checking rules, said fifth repository further configured to store said code checking rule(s); and
a third processor cooperating with said fifth repository and configured to execute said code checking rule(s) on the populated instance of said meta model, and determine whether said program code complies with said code checking rule(s); and
a report generator cooperating with said rule engine and configured to generate at least one report indicating the compliance level of said program code with said code-checking rule(s).

2. The computer implemented system as claimed in claim 1, wherein said system further includes:
a time stamp checker configured to receive said program code, said program code comprising a first time stamp indicating the date of and the time at which said program code was last modified, and a second time stamp indicating the date of and time at which said program code was previously checked by said system; and
a comparator configured to compare said first time stamp and said second time stamp, and instruct said report generator to generate a report in the event that first time stamp is less than said second time stamp; said comparator further configured to instruct said lexical analyzer to lexically analyze said program code, in the event that said first time stamp is greater than said second time stamp.

3. The computer implemented system as claimed in claim 1, wherein said system further comprises a translator configured to selectively translate said code checking rule(s) into a format compatible with said meta model, prior to the execution of said code checking rule(s).

4. The computer implemented system as claimed in claim 1, wherein said instance of the meta-model is an entity-relationship model.

5. The computer implemented system as claimed in claim 1, wherein said code checking rule(s) are organized into a plurality of rule bases.

6. The computer implemented system as claimed in claim 1, wherein said system further includes an activator accessible to said reviewer, said activator configured to enable said reviewer to selectively activate the code checking rule(s) organized into said plurality of rule bases.

7. The computer implemented system as claimed in claim 1, wherein said system further includes a rule-editor configured to enable said reviewer to edit the code checking rule(s).

8. A computer implemented method for checking a program code, said method comprising the following steps:
storing, a pre-determined set of lexical rules on a first repository, a pre-determined set of parsing rules on a second repository, at least one meta model in a third repository, at least one set of populating rules corresponding to said meta model on a fourth repository;
lexically analyzing the expressions of said program code using said set of lexical rules and generating tokens corresponding to the expressions provided in said program code;
parsing said tokens using said set of pre-determined parsing rules and determining whether said token form an allowable expression;
generating a parsed tree representing the relationship between said tokens in a tree-format;
receiving the parsed tree at an abstractor and selectively extracting said meta model and said at least one set of populating rules corresponding to said meta model;
generating a populated instance of said meta model based on said parsed tree and in accordance with said populating rules;
enabling a reviewer having access to said program code and corresponding program requisites, to frame at least one code checking rule, said code checking rule being in accordance with said program requisites;
storing said code checking rule(s) in a fifth repository;
receiving the populated instance of said meta model at a rule engine and selectively extracting said code checking rule(s), and further implementing said code checking rule(s) on the populated instance of said meta model; and
determining whether said program code complies with said code-checking rules, and generating at least one report indicating the compliance level of said program code with said code-checking rules.

9. The computer implemented method as claimed in claim 8, wherein said method further includes the following steps:
extracting a first time stamp, wherein said first time stamp indicates the date of and time at which said program code was last modified;
extracting a second time stamp, wherein said second time stamp indicates the date of and time at which said program code was last checked by said system; and
comparing the first time stamp with the second time stamp.

10. The computer implemented method as claimed in claim 9, wherein the step of comparing said first time stamp with said second time stamp further includes the step of instructing a report generator to generate a report indicating the compliance level of said program code with said code-checking rules, in the event that first time stamp is less than said second time stamp.

11. The computer implemented method as claimed in claim 9, wherein the step of comparing said first time stamp with said second time stamp further includes the step of instructing a lexical analyzer to lexically analyze said program code, in the event that said first time stamp is greater than said second time stamp.

12. The computer implemented method as claimed in claim 8, wherein said method further includes the step of selectively translating said code checking rule(s) into a format compatible with said meta model, prior to the execution of said code checking rule(s).

13. The computer implemented method as claimed in claim 8, wherein the step of generating the populated instance of said meta model further includes the step of generating an entity relationship model.

14. The computer implemented method as claimed in claim 8, wherein said method further includes the step of organizing said code checking rules into a plurality of rule bases.

15. The computer implemented method as claimed in claim 8, wherein said method further includes the step of enabling a code reviewer to selectively activate said code checking rules organized into said plurality of rule bases.

16. The computer implemented method as claimed in claim 8, wherein said method further includes the following steps:
enabling the reviewer to customize the created code checking rules; and
updating said fifth repository with customized code checking rules.
